(19) United States
(12) Patent Application Publication
(10) Pub. No.: US 2023/0264115 A1
(43) Pub. Date: Aug. 24, 2023

(54) METHOD FOR SEPARATING WATER AND CONTAMINANTS FROM VALUABLE OR HARMFUL LIQUIDS

(71) Applicant: Craig Nazzer, Oakura, New Plymouth (NZ)

(72) Inventor: Craig Nazzer, Oakura, New Plymouth (NZ)

(21) Appl. No.: 18/020,263

(22) PCT Filed: Aug. 13, 2021
(86) PCT No.: PCT/NZ2021/050129

§ 371 Date: Feb. 7, 2023

(30) Foreign Application Priority Data
Aug. 14, 2020 (NZ) 767167
Mar. 8, 2021 (NZ) 773689
May 17, 2021 (NZ) 776163

(51) Int. Cl. B01D 3/06; B01D 1/14; C02F 1/06

(52) U.S. Cl. CPC B01D 3/06; B01D 1/14; C02F 1/06; C02F 2101/34

(57) ABSTRACT

The present disclosure is a method of removing water and contaminants from an aqueous feed stream comprising a water soluble process liquid. Embodiments of the method may include splitting the method into stages, vaporising the process liquid by direct contact with a heated heating fluid, removing precipitated contaminants by chemical means, and treating the heating fluid to maintain or enhance its properties.

### FIELD OF THE INVENTION

The present disclosure is directed to methods for separating water and contaminants from valuable or harmful water-soluble process liquids. These process liquids include glycols and amines that are less volatile than water including those that are used for oil and gas processing.

### BACKGROUND

Water soluble liquids such as glycols and amines are used in oil and gas production and refining. They are typically less volatile than water and can become diluted by water and contaminated by dissolved solid matter and by liquid contaminants in many cases. For economic and environmental reasons, it is standard practice to apply treatment methods to remove at least a portion of the water and contaminants and reuse the liquid. Examples of such treatment methods are disclosed in U.S. Pat. Nos. 6,685,802, 8,728,321 and 8,652,304 incorporated herein by reference.

At oil and gas production facilities, the fluids that come from the oil and gas wells may contain substantial amounts of condensed water and formation water. These fluids often contain dissolved salts and other unwanted contaminating substances. At many of these facilities, mono-ethylene glycol (“MEG”) is injected into hydrocarbon flow lines to inhibit the formation of hydrates that can otherwise plug pipelines. MEG and water are mutually miscible hence they form a dilute aqueous glycol solution flowing in the pipework with the hydrocarbons. When the crude hydrocarbons are collected at the oil and gas production plant, the dilute aqueous glycol solution, which is termed “rich MEG” in the oil and gas industry, is typically separated from hydrocarbons using gravity. The rich MEG is then filtered and reconcentrated, also known as “regenerated”, typically to about 70 to 90% by boiling off water to create what is known as “lean MEG”. The lean MEG is transported back upstream to be reinjected into the hydrocarbon production pipework. In this way, the glycol is reused many times. However, in the absence of remedial measures, contaminants which typically include dissolved solid matter (e.g. salts) and unwanted liquids accumulate in the lean MEG each time the MEG is separated, reconcentrated, and used again.

The contamination in the glycol can cause increased corrosion, thermal degradation of the glycol, unwanted precipitation of solid matter, fouling of heat transfer equipment and other serious, costly, operational problems. Chlorides, oxides, sulfates, bicarbonates, and carbonates of sodium, potassium, calcium, magnesium, iron, barium, and strontium are examples of inorganic contaminants. Sodium chloride is often the most prevalent dissolved contaminant in the rich MEG. Other dissolved salt contaminants comprised of divalent ions (e.g. calcium, magnesium) are also frequently present. Organic acids and organic acid salts (e.g. acetates, propionates) can also be troublesome contaminants. A major source of the dissolved contaminants is formation water that flows with the hydrocarbon fluids out of the oil and gas production wells. Another source can be the brines (e.g. calcium chloride brine and calcium bromide brine) and other fluids that are used during drilling or are injected into the flow lines during or after exploration to prepare for initial production, or as a result of well maintenance activities. Other sources of contamination might include the products of corrosion of the flow lines and the chemicals injected into the flow lines to control scaling and corrosion. In the oil and gas industry the process of removing at least a portion of the dissolved contaminants so as to maintain the quality of the glycol when it is reused is called “MEG reclamation”.

In facilities that reclaim glycol (e.g. MEG) using a “flash vaporisation” process such as those disclosed in U.S. Pat. Nos. 6,685,802 and 8,728,321, a feed stream comprising an aqueous glycol solution containing contaminants including dissolved inorganic salts is caused to boil rapidly upon mixing with a heated stream of concentrated glycol within and/or upstream of a flash separation vessel. Methods in which water and process liquid are vaporised by direct contact with a heated quantity of concentrated process liquid are herein termed “Flash on Process Liquid” processes. Typically at least some of the vaporised components of the feed stream are subsequently condensed or further separated by distillation into water and concentrated process liquid.

When used for MEG reclamation the process is normally run under vacuum at an absolute pressure of 0.1 to 0.5 bara so as to reduce the operating temperature which is typically good practice when treating a thermally sensitive process liquid such as MEG. The concentrated MEG that has been, or will be, heated and mixed with the feed stream to cause the flash vaporisation described above is drawn from a liquid pool in the lower part of the flash separation vessel. One non-limiting example of the heating method comprises pumping a portion of the concentrated MEG out of the liquid pool and through a heater to raise its temperature and then mixing the heated pumped MEG with the feed stream as the feed stream enters the flash separation vessel. The vaporisation causes dissolved salts in the feed stream to precipitate. The precipitated salts along with other non-volatile contaminants, if any are present, accumulate in the liquid in the liquid pool.

The Flash on Process Liquid method when used for MEG reclamation typically includes additional mechanical separation equipment such as centrifuges, settling tanks, clarifiers or filters to separate the precipitated and suspended solids from the pool of concentrated process liquid in the flash separation vessel. The solids are typically then disposed of. The need for these added equipment items results in disadvantages such as complexity, higher capital cost and operating cost, increased weight and footprint, loss of process liquid with the waste solid matter, and risk of harm to the environment due to loss of process liquid.

In the flash separation vessel sodium chloride typically precipitates in the form of distinct particles that can be separated by gravity or other mechanical means. In reference to the non-limiting example of MEG reclamation it has been widely observed that the vaporisation of the water and glycol in the feed stream and the precipitation and removal of monovalent salts including sodium chloride and potassium chloride (noting that typically most of the salts in rich MEG are monovalent salts) can be done using the above described means. However, this process does not address the problems that occur when the MEG in the flash separation vessel becomes excessively contaminated with divalent ions.

Calcium and other troublesome divalent ions are typically present in rich MEG. If the feed stream contains significant quantities of calcium, then in the absence of extra treatment, the calcium accumulates in the concentrated MEG in the liquid pool in the flash separation vessel. Calcium ions that are dissolved in concentrated MEG do not reliably precipitate to form well behaved particles in the Flash on Process Liquid process. Instead, the calcium ions can combine with MEG and chloride ions to form complex calcium-glycol-chloride compounds that solidify if allowed to cool to less than about 95° C. This has been a costly experience at several operating plants. Other divalent ions including magnesium can cause a similar effect.

The presence of calcium and other divalent ions in the feed stream to the MEG reclamation system is often unavoidable given that the compositions of several types of subsurface hydrocarbon reservoir rock (e.g. limestone) include such elements. Furthermore, when wells are drilled or made ready for production the operators may use high density fluids that contain dissolved calcium (e.g. calcium chloride, calcium bromide etc), which can subsequently flow through the hydrocarbon production pipework and into the MEG reclamation system. This divalent ion problem is described in Reference 1.

Plant designers have sought to address the divalent ion problem by including an additional treatment system. In a typical version of this additional system an aqueous solution of a treatment chemical (e.g. sodium carbonate) is added to the rich MEG feed stream upstream of the flash vaporisation process. The calcium ions react with the added carbonate ions to form particles of waste matter (e.g. calcium carbonate) which may then be mechanically separated (e.g. by filtration) from the MEG and disposed of. Hence additional waste matter is created by this method of dealing with the divalent ion problem. Drawbacks with this divalent ion treatment process, include: the cost and complexity of adding chemicals to the feed stream; and the size, cost and complexity of the additional mechanical separation equipment needed to remove the additional waste matter. Furthermore the mechanical separation equipment will leave at least a coating of process liquid on the waste particle surfaces, thereby increasing the potential risk of loss of process liquid and harm to the environment.

The processes disclosed in U.S. Pat. Nos. 8,652,304 and 10,328,360 are more recent variations of the flash vaporisation process in which an alternative heating medium, herein termed “heating fluid”, which may, for example, be an oil or oil-like liquid, is heated and mixed with the feed stream to vaporise process liquid instead of using concentrated process liquid for this purpose. In the present disclosure the term “Flash on Heating Fluid process” means a process that uses direct contact between a process liquid and a heated heating fluid to vaporise at least a portion of the process liquid, thereby separating contaminants from the process liquid.

U.S. Pat. Nos. 8,652,304 and 10,328,360 describe versions of the Flash on Heating Fluid process. Both inventions entail filling a flash separation vessel with a large quantity of a heating fluid that is less volatile than and immiscible with the process liquid. For the example of MEG reclamation many suitable heating fluids that have these properties will be oily, or expensive to purchase, or potentially harmful or hazardous. This fluid is heated and mixed with contaminated process liquid, thereby causing non-volatile contaminants, including at least some of those that had originally been in the contaminated process liquid, to mix with and contaminate the pool of heating fluid in the flash separation vessel.

U.S. Pat. Nos. 8,652,304 describes the precipitation and removal of contaminants comprising monovalent salts, including sodium chloride, from an aqueous MEG feed stream.

The precipitated salts accumulate in the pool of heating fluid and are removed by mechanical means that include settling through a stripping process.

In U.S. Pat. No. 10,328,360 the stated process objective is “partial vaporisation” of the volatile components (i.e. water and process liquid) in a “process stream”. Dissolved salts remain dissolved in the unvaporised portion of the process stream. Blowdown is described as a means of removing a mixture of heating fluid and unvaporised process liquid thereby removing dissolved salts. Using blowdown to remove unwanted dissolved substances from valuable process liquids is a well known method used in many industries however due to solubility limits the amount of process liquid that is lost in a blowdown stream is typically substantially more than the amount of unwanted dissolved substance. This may be acceptable when recovering from temporary operating problems or if no harm is caused by the loss of process liquid but it may not be tolerable for the routine processing of salty glycol. The solubility of common salts in MEG is only about one sixth of that in water. Because of the low solubility of salt in MEG this blowdown method to remove sodium chloride at a MEG reclamation site would result in losing several litres of MEG for each kilogram of dissolved salt that is removed. MEG loss of this magnitude is much higher than what currently occurs at MEG reclamation sites that use the older Flash on Process Liquid process (e.g. U.S. Pat. Nos. 6,685,802 and 8,728,321).

In U.S. Pat. No. 10,328,360 undissolved solid matter is removed by mechanical separation devices specified as “hydrocyclone, centrifuge, particulate filter, settling tank or some other piece of separation device equivalent to these”. These devices separate solid matter from surrounding liquid that in U.S. Pat. No. 10,328,360 is predominantly comprised of a mixture of heating fluid (which may be oily or valuable or hazardous) and process liquid. The separated waste solid matter will remain coated, if not immersed, in a mixture of heating fluid and process liquid leading to loss of both liquids and an accompanying risk of harm to the environment.

The accumulation of contaminants in the heating fluid can cause deterioration or other unwanted changes to the properties of the heating fluid. Neither U.S. Pat. Nos. 8,652,304 nor 10,328,360 disclose remedial measures to rectify heating fluid contamination and/or degradation. Deterioration of the heating fluid may impair its capacity to separate contaminants from the process liquid during the vaporisation process. For the example of MEG reclamation, there is a near infinite range of potential contaminants that can flow from the oil and gas wells. A person skilled in the art knows that it is impossible to know in advance exactly what will come out of the hydrocarbon reservoirs year after year. Furthermore, there are numerous ways to respond if oil or gas production problems arise. Many of these responses involve adding chemicals to the well stream, which can end up in the rich MEG. Furthermore, equipment that is supposed to intercept contaminants upstream of the MEG reclamation system may be undersized or fail to perform. Faults or operational errors can occur. There have been, and will continue to be, unwelcome surprises in the rich MEG composition at numerous oil and gas production sites. The emphasis is typically on maintaining hydrocarbon production while the MEG reclamation system copes with an extensive, often unpredictable, assortment of unwanted substances. The present disclosure provides means to remove contaminants from, and maintain or improve the quality of, the heating fluid used in the Flash on Heating Fluid process thereby improving the reliability of MEG reclamation systems. In the present disclosure the term “decontaminate” the heating fluid means remove, nullify, dissolve, destroy, or otherwise eliminate at least a portion of any one or more of the contaminants that may be in the heating fluid used in the Flash on Heating Fluid process.

Contaminants that are known to cause problems in MEG reclamation systems include acetate, propionate and other organic acid salts. Liquid contaminants can also be problematic by interfering with the operation of equipment or instruments or by promoting the formation of sludges or gums or sticky residues. Examples include resins, tars, asphaltenes, waxes and the like. Other contaminants can cause or promote scaling and corrosion. Another source of contamination can be thermal degradation of the glycol (e.g. oxalic acid, formic acid, glycolic acid etc).

Contamination and other changes to the heating fluid can also have a knock-on effect on the quality of the output stream of lean MEG. Contaminants in the heating fluid can inadvertently be transmitted back into the output product stream.

U.S. Pat. No. 8,652,304 specifies that the heating fluid is oily or oil-like which is an unnecessary restriction. It has been discovered that for some applications other liquids including ionic liquids and deep eutectic solvents may be, or may in future become, suitable candidates for use in the heating fluid.

The prior art does not disclose methods of rectifying or preventing the contamination, deterioration or other forms of degradation of the heating fluid.

The shortcomings in the prior art are solved or avoided or at least ameliorated in the present disclosure in which the Flash on Heating Fluid process is substantially modified by: specifying a broad range of fluids that can perform the functions of the heating fluid; adding novel chemical separation means to remove contaminants (e.g. by dissolving sodium chloride) that would otherwise accumulate to an excessive degree in the heating fluid; and adding further novel heating fluid treatment means (“HFTM”) that comprise means to enhance, decontaminate, restore, and/or regenerate the heating fluid and/or improve, or rectify unwanted changes to, its composition and/or properties.

The present disclosure also comprises novel embodiments wherein the method of separating water and contaminants from process liquids is split into several process stages, including a Flash on Heating Fluid stage. Heating fluid is only used in the Flash on Heating Fluid process, which, may result in significantly less energy consumption when compared to what would be required using the prior art disclosed in U.S. Pat. No. 8,652,304 or 10,328,360 to remove a similar quantity of contaminants from a similar quantity of process liquid. The reduction in energy demand enables corresponding reductions in: the size and cost of the pool of heating fluid; the sizes and costs of equipment needed to hold, pump and heat the heating fluid; losses of heating fluid (if less heating fluid is heated than losses can be expected to be lower); and the risks of inadvertently transferring unwanted substances from the heating fluid to the output stream of clean concentrated process liquid.

The reduced size of the pool of heating fluid results in a corresponding significant reduction in the cost to modify the composition of the heating fluid. For example, in MEG reclamation the flexibility to modify the heating fluid can help optimise the treatment of oil and gas well streams that often have widely varying flowrates of MEG, water and contaminants over many years of production. Typically, many wells start with little or no formation water flow. When there is formation water breakthrough the actual quantity and composition of the salts and other contaminants can be markedly different from the design case used for initial construction. The present disclosure provides options for making changes to the quantity and composition of the heating fluid to optimise performance at lower cost compared to the prior art because the pool of heating fluid is much smaller. The operator may choose to replace contaminated degraded heating fluid with fresh heating fluid or change the composition of or type of heating fluid. Furthermore, in future better heating fluids may be developed, such as by incorporating newly developed types of liquids (e.g. ionic liquids or deep eutectic solvents), and it will be easier and less costly using the present disclosure to take advantage of such technological progress.

### SUMMARY OF INVENTION

In a first aspect, there is a provided a method of removing contaminants, including dissolved contaminants, from a feed stream, said feed stream comprising water and said contaminants and a process liquid that is water soluble and less volatile than water, said method comprising the following steps:
a) heating a heating fluid comprised of components that are immiscible with a salt solvent and less volatile than the process liquid to produce a heated heating fluid;
b) bringing at least a portion of the feed stream into contact with at least a portion of the heated heating fluid at one or more places that are upstream of and/or within a flash separator to vaporise at least a portion of the process liquid thereby causing at least a portion of the dissolved contaminants to form precipitated solid matter;
c) enabling at least a portion of the heating fluid to mix with at least a portion of the precipitated solid matter thereby producing a depleted mixture that comprises at least a portion of the heating fluid and at least a portion of the precipitated solid matter; and
d) bringing the salt solvent into contact with at least a portion of the depleted mixture whereby said salt solvent dissolves at least a portion of the precipitated solid matter, to create a waste solution that comprises at least a portion of the dissolved contaminants.

In a second aspect, there is a provided a method of removing contaminants, including dissolved contaminants, from a feed stream, said feed stream comprising water and said contaminants and a process liquid that is water soluble and less volatile than water, said method comprising the following steps:
a) applying a concentration process to remove water from at least a portion of the feed stream to produce a Stage A output stream having a concentration of process liquid that is higher than that of the feed stream;
b) heating a heating fluid comprised of components that are immiscible with a salt solvent and less volatile than the process liquid to produce a heated heating fluid;
c) bringing at least a portion of the Stage A output stream into contact with at least a portion of the heated heating fluid at one or more places that are upstream of and/or within a flash separator to vaporise at least a portion of the process liquid thereby causing at least a portion of the dissolved contaminants to form precipitated solid matter;
d) enabling at least a portion of the heating fluid to mix with at least a portion of the precipitated solid matter thereby producing a depleted mixture that comprises at least a portion of the heating fluid and at least a portion of the precipitated solid matter; and
e) bringing the salt solvent into contact with at least a portion of the depleted mixture, whereby said salt solvent dissolves at least a portion of the precipitated solid matter to create a waste solution that comprises at least a portion of the dissolved contaminants.

In one embodiment of the methods defined above the concentration process comprises heating the feed stream to a temperature sufficient to vaporise and remove at least a portion of the water.

In a third aspect there is a provided a method of removing contaminants, including dissolved contaminants, from a feed stream, said feed stream comprising water and said contaminants and a process liquid that is water soluble and less volatile than water, said method comprising the following steps:
a) heating a concentrated process liquid to produce heated concentrated process liquid;
b) bringing at least a portion of the feed stream into contact with at least a portion of the heated concentrated process liquid at one or more places that are upstream of and/or within a Stage B separation vessel to vaporise a portion of the process liquid thereby producing an unvaporised liquid that comprises at least a portion of the dissolved contaminants;
c) enabling at least a portion of the unvaporised liquid to mix with at least a portion of the concentrated process liquid thereby producing a Stage B to C stream that comprises at least a portion of the process liquid and at least a portion of the dissolved contaminants;
d) heating a heating fluid comprised of components that are immiscible with a salt solvent and less volatile than the process liquid to produce a heated heating fluid;
e) bringing at least a portion of the Stage B to C stream into contact with at least a portion of the heated heating fluid at one or more places that are upstream of and/or within a flash separator to vaporise at least a portion of the process liquid thereby causing at least a portion of the dissolved contaminants to form precipitated solid matter;
f) enabling at least a portion of the heating fluid to mix with at least a portion of the precipitated solid matter thereby producing a depleted mixture that comprises at least a portion of the heating fluid and at least a portion of the precipitated solid matter; and
g) bringing the salt solvent into contact with at least a portion of the depleted mixture whereby said salt solvent dissolves at least a portion of the precipitated solid matter, thereby creating a waste solution that comprises at least a portion of the dissolved contaminants.

In the above aspect there is provided an embodiment wherein the flow of the Stage B to C stream is regulated to limit the accumulation of at least a portion of the dissolved contaminants in the Stage B separation vessel

In any of the aspects above there are provided embodiments wherein one or more heating fluid treatment means are applied to decontaminate at least a portion of the heating fluid and/or to modify the properties of the heating fluid.

In any of the aspects above there are provided embodiments wherein one or more substances are added and mixed with at least a portion of the heating fluid to cause a reaction with carbonate and/or bicarbonate contaminants thereby producing water and/or carbon dioxide.

In any of the aspects above there are provided embodiments wherein one or more substances are added and mixed with at least a portion of the heating fluid to cause a reaction that converts at least a portion of the organic salt contaminants, including acetate, into volatile organic acids, including acetic acid, and vaporising at least a portion of said volatile organic acids.

In any of the aspects above there are provided embodiments wherein one or more substances are added and mixed with at least a portion of the heating fluid to remove and/or dissolve and/or destroy asphaltenes, resins, gums and/or sludges.

In any of the aspects above there are provided embodiments wherein one or more substances are added and mixed with at least a portion of the heating fluid to prevent or inhibit the formation of, or enable the removal of, scale or fouling deposits on metal surfaces.

In any of the aspects above there are provided embodiments wherein one or more substances are added and mixed with at least a portion of the heating fluid to break-down, suppress, or inhibit the formation of, emulsions or foam.

In any of the aspects above there are provided embodiments wherein one or more substances are added and mixed with at least a portion of the heating fluid to reduce the cloud point and/or freezing point of liquid contaminants.

In any of the aspects above there are provided embodiments wherein one or more substances are added and mixed with at least a portion of the heating fluid to neutralise acids and/or increase alkalinity and/or inhibit corrosion.

In any of the aspects above there are provided embodiments wherein one or more substances are added and mixed with at least a portion of the heating fluid to react with dissolved contaminants and cause precipitation of solid matter that can be removed by mechanical means of separation.

In any of the aspects above there are provided embodiments wherein one or more substances are added and mixed with at least a portion of the heating fluid to reduce the oxygen content of the heating fluid.

In any of the aspects above there are provided embodiments wherein one or more substances are added and mixed with at least a portion of the heating fluid to modify one or more of the properties of the heating fluid including but not limited to density, vapour pressure, viscosity, thermal stability, pH, solubility, heat capacity, thermal conductivity, corrosivity, toxicity, and flammability.

In any of the aspects above there are provided embodiments wherein at least a portion of the heating fluid is heated to vaporise and thereby remove at least a portion of the liquid contaminants.

In any of the aspects above there are provided embodiments wherein at least a portion of the liquid contaminants are removed from the flash separator in liquid form.

In any of the aspects above there are provided embodiments wherein mercury is removed from at least a portion of the heating fluid.

In any of the aspects above there are provided embodiments wherein contaminating particles of solid matter are removed from at least a portion of the heating fluid by mechanical means of separation including but not limited to any one or more of: centrifuging, settling, clarifying, filtering, and hydrocycloning.

In any of the aspects above there are provided embodiments wherein the one or more heating fluid treatment means include adding one or more substances and mixing said added substances with at least a portion of the heating fluid to cause a reaction that converts at least a portion of the organic salt contaminants into volatile organic acids and vaporising at least a portion of said volatile organic acids.

In any of the aspects above there are provided embodiments wherein an electric voltage or current is applied to at least a portion of the heating fluid thereby causing ions of contaminating substances to migrate towards electrodes from which they may be removed.

In any of the aspects above there are provided embodiments wherein the heating fluid comprises components that are immiscible with the process liquid.

In any of the aspects above there are provided embodiments wherein the salt solvent comprises water.

In any of the aspects above there are provided embodiments wherein the process liquid comprises any one or more liquids selected from the group comprising: mono-ethylene glycol; diethylene glycol; triethylene glycol; and amines.

In any of the aspects above there are provided embodiments wherein the dissolved contaminants comprise any one or more of: monovalent salts including sodium chloride; divalent ions including calcium; and organic acid salts including acetate.

In any of the aspects above there are provided embodiments wherein at least all but a negligible remnant of the process liquid that contacts the heated heating fluid is vaporised.

In any of the aspects above there are provided embodiments wherein at least 95%, or preferably at least 98%, of the process liquid that contacts the heated heating fluid is vaporised.

In any of the aspects above there are provided embodiments wherein at least a portion of the vaporised process liquid is condensed.

In any of the aspects above there are provided embodiments wherein at least a portion of the heating fluid is heated by a heating device that is inside the flash separator and/or by flowing through a heater that is located outside of the flash separator.

In any of the aspects above there are provided embodiments wherein the flash separator is operated at a pressure below atmospheric pressure.

In any of the aspects above there are provided embodiments wherein the heating fluid comprises one or more liquid components selected from any of the following groups: oils; fatty acids; heat transfer fluids; liquid metals; ionic liquids; and deep eutectic solvents.

In any of the aspects above there are provided embodiments wherein at least a portion of the salt solvent enters the flash separator and mixes with depleted mixture and dissolves at least a portion of the precipitated solid matter thereby creating a waste solution that comprises at least a portion of the dissolved contaminants.

In any of the aspects above there are provided embodiments wherein at least a portion of the depleted mixture moves into a solvent wash system wherein at least a portion of the precipitated solid matter dissolves in at least a portion of the salt solvent, thereby creating a waste solution that comprises at least a portion of the dissolved contaminants. Further embodiments are provided wherein the operating temperature and pressure in the solvent wash system are regulated in a manner that avoids boiling the salt solvent in the solvent wash system.

### BRIEF DESCRIPTION OF THE DRAWINGS

FIG. 1 presents an overview of options for arranging the separate stages of the overall method. These include a three stage option (Stages A plus B plus C), a pair of two-stage options (Stages A plus C, and Stages B plus C) and a single stage option (stand-alone Flash on Heating Fluid).

FIG. 2 presents a non-limiting example of the stand-alone Flash on Heating Fluid optional configuration.

FIG. 3 presents a non-limiting example of the Stage A plus Stage C optional configuration.

FIG. 4 presents a non-limiting example of the Stage B plus Stage C optional configuration.

### DETAILED DESCRIPTION

The present disclosure provides methods that comprise configurations of process stages to achieve the objective of separating water, dissolved salts and other contaminants from a feed stream that comprises a solution of water and water-soluble process liquid such as but not limited to glycols including mono-ethylene glycol (MEG), and amines. In embodiments, the stages may comprise the following processes: Concentration, herein labelled “Stage A”; Flash on Process Liquid, herein labelled “Stage B”; and Flash on Heating Fluid, herein labelled “Stage C”.

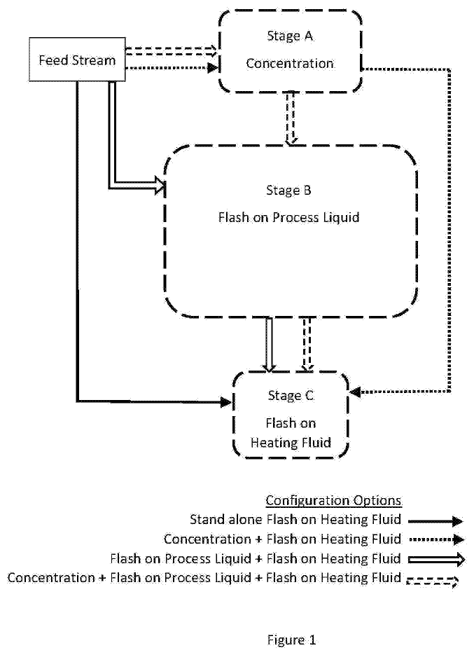

FIG. 1 presents an overview of embodiments of the present disclosure. These may comprise a three stage option (Stages A plus B plus C), a pair of two-stage options (Stages A plus C, and Stages B plus C) and a stand-alone Flash on Heating Fluid process.

In embodiments for a three stage option, the feed stream comprising an aqueous process liquid solution enters Stage A in which water is removed from the feed stream thereby creating a concentrated process liquid solution. For example this stage of the method could include heating the feed stream so as to vaporise at least a portion of the water and separating the vaporised water from the unvaporised portion of the feed stream. The concentrated process liquid produced in Stage A might then flow to Stage B where it is heated and partially vaporised using, for example, a Flash on Process Liquid process in which the vaporisation heat is provided by heating a stream of concentrated process liquid and mixing this heated concentrated process liquid stream with the feed stream. Vapour from Stage B might be condensed to produce an output stream of substantially salt free concentrated process liquid. An unvaporised residual stream of concentrated process liquid containing dissolved and precipitated salts and other contaminants may flow to Stage C. Salts and other contaminants might be removed in Stage C using the Flash on Heating Fluid process in which heated heating fluid provides the heat to vaporise process liquid. The vaporised process liquid in Stage C might be condensed to produce an output stream of substantially salt free concentrated process liquid.

In the present disclosure, the term “concentrated process liquid” means a liquid having an elevated concentration of process liquid within a range extending from 0.1% higher than the concentration of process liquid in the feed stream 10 up to 100% process liquid.

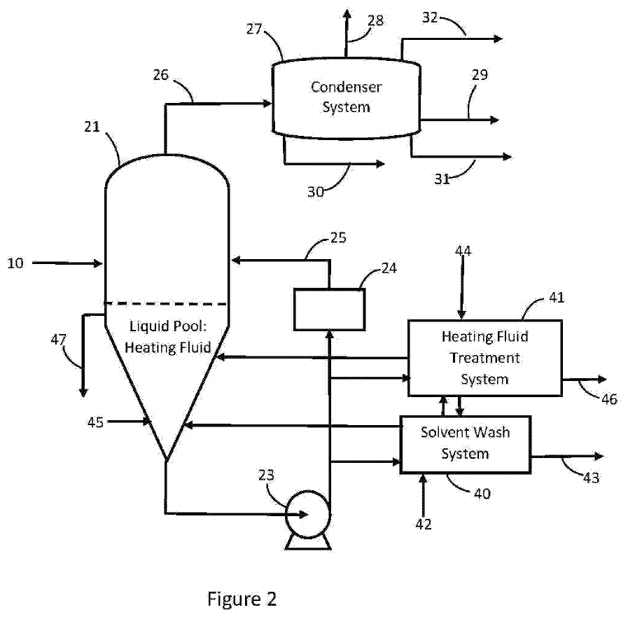

Non-limiting examples of the preferred embodiments are illustrated in FIGS. 2, 3 and 4 and described below.

### Stand-Alone Flash on Heating Fluid

FIG. 2 illustrates a non-limiting example of the stand-alone Flash on Heating Fluid configuration. With reference to the embodiments illustrated in FIG. 2, a feed stream 10 comprises water, a water soluble process liquid that is less volatile than water, dissolved contaminants including monovalent salts (e.g. sodium chloride), divalent ions (e.g. calcium and magnesium), and organic salts (e.g. acetate), and liquid contaminants. Feed stream 10 enters flash separator 21 through one or more entrance ports. Flash separator 21 is a Flash on Heating Fluid separation vessel that contains a liquid pool into which separated liquids and solid matter collect. In embodiments, the separated vapour is able to flow out of the upper part of flash separator 21. The liquid pool in flash separator 21 may contain heating fluid that comprises liquid components that are less volatile than the process liquid. Pump 23 might draw heating fluid out of flash separator 21 and pump it through heater 24 to create a stream 25 of heated heating fluid. Stream 25 and stream 10 directly contact each other in one or more places upstream of and/or within flash separator 21. For example there may be one or more mixing zones or chambers upstream of flash separator 21 into which both stream 10 and stream 25, or portions thereof, flow and mix with each other, and/or there may be multiple entrance ports into flash separator 21 for stream 10 and stream 25 thereby causing the two streams or portions thereof to mix with each other inside flash separator 21. Alternatively stream 10 or a portion of it may enter the liquid pool in flash separator 21 and therein contact heated heating fluid.

Sufficient heat is added to the heating fluid in heater 24 and/or by heating the heating fluid within flash separator 21 to cause at least a portion of the water and process liquid in stream 10 to vaporise when stream 20 contacts heated heating fluid.

In embodiments at least all but a negligible remnant, of the process liquid in stream 10 might be vaporised as a result of the contact between stream 10 and the heated heating fluid. In the present disclosure, the term “negligible remnant” means an amount that is not more than the allowable maximum loss of process liquid for the particular application of the present disclosure. For example in MEG reclamation application, if the allowable maximum loss of MEG is 0.5% then the term “at least all but a negligible remnant of the process liquid” means at least 99.5% of the MEG that is in feed stream 10.

In embodiments, over 95%, or preferably over 98%, of the process liquid in stream 10 might be vaporised as a result of the contact between stream 10 and the heated heating fluid.

A person skilled in the art will recognise that there are alternative feasible means of heating the heating fluid. In an embodiment at least a portion of the heating fluid might be heated while in the liquid pool of flash separator 21, for example by a submerged tube bundle or heating coils or vessel heating jacket or other type of heating device. This could be in addition to, or instead of, the pumped system shown in FIG. 2 (i.e. pump 23 and heater 24).

The following descriptions under the headings: Separation and Removal of Contaminants; Heating Fluid Composition; and Heating Fluid Treatment Means apply to embodiments of the present disclosure including those illustrated in FIGS. 2, 3, and 4.

### Separation and Removal of Contaminants

Vaporised process liquid and optionally vaporised liquid contaminants and optionally vaporised liquid components of the heating fluid, exit the flash separator 21 and flow via stream 26 into condenser system 27 in which separation and condensation of components of the vapour might be achieved using standard methods known to persons skilled in the art. The condenser system 27 might include equipment to enable operation of the flash separator 21 at below atmospheric pressure, for example at less than 0.5 bara, or less than 0.2 bara. Stream 28 might comprise non-condensed gases and vapour that might be subsequently removed. Stream 29 is an output product stream that may comprise concentrated process liquid that is depleted of salts and other contaminants. Stream 30 is optional and may comprise condensed heating fluid which can be subsequently returned to the flash separator 21 liquid pool. Stream 31 is optional and may comprise condensed liquid contaminants that are subsequently removed.

The Flash on Heating Fluid process removes dissolved contaminants (e.g. salts) by vaporising at least a portion of the liquids that contain the dissolved contaminants thereby causing dissolved contaminants to precipitate and accumulate in the pool of heating fluid in flash separator 21. In embodiments at least all but a negligible remnant, of the process liquid might be removed as vapour from flash separator 21. For the example of a MEG reclamation application, this might provide an effective simple solution to the divalent ion problem. In the present disclosure calcium and other divalent ions which might come out of solution as concentrations reach and exceed solubility limits are surrounded by heating fluid. The MEG molecules have been vaporised hence there is a shortage of MEG available to form the troublesome complex calcium-MEG-chloride compound. This enables calcium chloride and/or other non-troublesome calcium salts to precipitate and, along with precipitated monovalent salts, mix with the heating fluid in the liquid pool in flash separator 21. Calcium chloride is a well-known water soluble salt. The mixture of heating fluid and precipitated solid matter (e.g. salts) that consequently collects in the liquid pool in flash separator 21 is depleted of process liquid, and is herein termed “depleted mixture”.

In embodiments illustrated in FIGS. 2, 3 and 4, a portion of the depleted mixture might be pumped from flash separator 21 into a solvent wash system 40. A liquid, herein termed “salt solvent,” that comprises components that can dissolve at least a portion of the precipitated salts in the depleted mixture might flow into the solvent wash system 40 via a stream 42, make contact with the depleted mixture and dissolve at least a portion of the precipitated salts to create a salty waste solution. In embodiments, the heating fluid may be comprised of liquid components that are not miscible with the salt solvent and might be less dense than the waste solution. Hence, after the desired amount of salt has been removed, the desalted heating fluid might be readily separated from the salty waste solution and removed from the solvent wash system 40, and from there be further treated and/or be routed back into the flash separator 21. The separated salty waste solution flows out of the solvent wash system 40 via stream 43. In the example of a MEG reclamation application, the most prevalent dissolved contaminants are water soluble salts which enables water to be used as a component of the salt solvent.

In other applications the salt solvent may comprise other liquids (e.g. organic solvents, alcohols, deep eutectic solvents) that are capable of dissolving the particular contaminants that are present in such applications.

In an embodiment the solvent wash system might be operated at a pressure that is high enough to avoid boiling salt solvent when the depleted mixture contacts the salt solvent in the solvent wash system 40. The boiling could otherwise disrupt operations. Alternatively or in addition the depleted mixture can be cooled before contacting salt solvent in the solvent wash system 40.

In embodiments, the step of dissolving at least some precipitated salts might be done by temporarily stopping normal operation and adding salt solvent directly to the depleted mixture in the liquid pool in flash separator 21. This may require adjusting the operating temperature and pressure in the flash separator 21 to avoid boiling. The salt solvent would dissolve at least a portion of the precipitated solid matter, thereby creating a waste solution that contains dissolved contaminants and that may be separated from heating fluid and removed from flash separator 21.

In the Flash on Heating Fluid process the heating fluid might be intentionally repeatedly exposed to a wide range of substances that had originally been in feed stream 10 and have entered flash separator 21. Some of these substances might comprise unwanted contaminants (solid and liquid) that might not be removed in the solvent wash system 40. Some of these contaminants may cause the quality of the heating fluid to degrade. To rectify, or avoid, such degradation the Flash on Heating Fluid process according to one or more embodiments might include one or more heating fluid treatment means (HFTM), details of which are disclosed elsewhere in the present disclosure including under the heading Heating Fluid Treatment Means below, to decontaminate and/or modify the properties of the heating fluid and/or provide other remedial measures to maintain or enhance the condition and performance of the heating fluid. In the non-limiting illustrations in FIGS. 2, 3 and 4, a portion of the heating fluid might be pumped from flash separator 21 into a heating fluid treatment system (HFTS) 41 in which one or more of the HFTM might be performed. Stream 44 figuratively shows that chemicals may optionally be added to HFTS 41 to perform one or more HFTM. Contaminants are figuratively shown being removed via stream 46.

While some HFTM may be performed by pumping heating fluid into a HFTS, some other HFTM may be performed by, for example, directly adding chemicals to flash separator 21 via optional stream 45, or into feed stream 10 or at another effective location, and/or removing contaminants directly from flash separator 21. Some contaminants may optionally be drained out of flash separator 21 via stream 47 or be vaporised to flow out of flash separator 21 in stream 26 after which they could be removed via stream 28 and/or stream 31.

In embodiments, the present disclosure substantially reduces the risk of loss of process liquid in the waste streams with a corresponding reduction in risk of harm to the environment. In embodiments in which at least all but a negligible remnant, of the process liquid is removed as vapour from flash separator 21, there are no means by which a non-negligible amount of process liquid can enter, and be lost with, the waste solutions that contain the contaminants.

By comparison in the prior art solid waste matter is separated from process liquid using mechanical means (e.g. filter, clarifier, settling tank, centrifuge). This causes the loss of process liquid because the surfaces of the particles of waste solids that are disposed of will typically be covered by or immersed in process liquid to at least some degree.

### Heating Fluid Composition

The heating fluid is comprised of components that are less volatile than the process liquid, immiscible with the salt solvent, and selected from one or more of the following groups: unrefined hydrocarbon oils including undistilled crude oil, diesel, fuel oil, middle distillate, one or more other distilled crude oil fractions; refined hydrocarbon oils including base oil, hydrocracked base oil; synthetic oils and silicone oils; non-hydrocarbon oils including vegetable oils, seed oils, fish oils, bio-diesel, other animal oils; fatty acids including oleic acid, erucic acid, other fatty acids; heat transfer fluids including those used in solar energy facilities; hydraulic oils, lubricating oils and transmission fluids; liquid metals including gallium and gallium alloys, woods metal, lead tin bismuth alloys, fusible alloys; ionic liquids; deep eutectic solvents; other fluids whose volatility is negligible or at least low enough to avoid excessive vaporisation.

Some types of fluids have been recently discovered or invented, including many ionic liquids and deep eutectic solvents. These fluids may not yet be suitable for widespread deployment due to high cost, however they are the subject of extensive ongoing research. A non-limiting range of such fluids proposed for heat transfer applications, which might at some time in the future include potential use as components of the heating fluid in the present disclosure, is described in WO2017/085600.

### Heating Fluid Treatment Means (HFTM)

The quality of the heating fluid can deteriorate over time due to its repeated mixing with contaminated process liquid. HFTM are included in this disclosure to maintain or enhance the quality of the heating fluid.

In the non-limiting example of MEG reclamation, as described above, most of the contaminants comprise water soluble salts that can be removed by including water as a component, possibly the only component, of the salt solvent. However, there can be numerous other types and sources of contamination of the heating fluid, as discussed below.

The heating fluid is continuously being mixed with more and more contaminants, day after day. These contaminants can accumulate and cause undesirable changes to the heating fluid properties such as its thermal stability, chemical stability, density, acidity, alkalinity, viscosity, boiling point, solubility, thermal conductivity, heat capacity, corrosivity, toxicity, flammability and/or surface tension. In the example of MEG reclamation, upstream systems that normally intercept or counteract contaminants (e.g. filters, chemical dosing treatments) may fail or be overwhelmed by unusual process conditions, thereby allowing slugs of contaminating substances to enter the reclamation facility and mix with the heating fluid.

The prior art does not include means to avoid or rectify contamination, deterioration and degradation of the heating fluid. Means to preserve or enhance the quality of the heating fluid are desirable so that it can be used repeatedly over and over again for months or years. If a user has to frequently discard heating fluid due to deterioration of its quality and replace it with new clean heating fluid, or alternatively has to send it elsewhere to be cleaned up, then that can be costly. The present disclosure reduces or avoids these costs by including a range of optional means to treat the heating fluid and extend its lifetime.

Some contaminants may form an unwanted sludge or rag layer. Asphaltenes, resins, waxes and/or other organic contaminants, including those that flow from the wells, may form sticky substances that adhere to equipment surfaces and foul heaters or form troublesome sludge and gum up instrumentation. Contaminants may flow out of the of the separation vessel with the vapour stream and then re-contaminate the condensed process liquid. Contaminants may be created by the oxidation or thermal degradation of the process liquid or the heating fluid itself. Contaminants may react with the process liquid or the heating fluid to form substances that are difficult to remove.

Mercury is a toxic substance that can contaminate the fluids entering a MEG reclamation facility.

Oxygen which can enter in dissolved form in rich MEG or dissolved in added liquids or enter due to air leaks, can accelerate corrosion and the degradation of some process liquids including MEG.

Ions of calcium, sodium, potassium, barium, iron, strontium, magnesium and the like can combine with carbonate, bicarbonate, hydroxide, sulfide, and/or sulfate ions to form precipitates that cause scaling and fouling. The accumulation of acids in the heating fluid may cause or accelerate corrosion. Fine particles of contaminants such as clays may become trapped in foams or emulsions in the heating fluid. The ingredients in chemical substances (e.g. corrosion inhibitor, dispersant, demulsifier, defoamer, pH control agent, scale inhibitor) that have been added to the process liquid before it enters the apparatus used to perform the present disclosure can be carried into the heating fluid and cause unwanted changes to its properties or otherwise impair its performance.

The HFTM include means to avoid or rectify these problems. The range, types and capacities of the HFTM are expected to vary to match the nature of and severity of contamination and degradation encountered in each particular application.

The present disclosure enables the inclusion of any one or more HFTM selected from the following list:
Adding one or more substances and mixing the added substances with at least a portion of the heating fluid to achieve any one or more of the following effects: to cause a reaction with carbonate and/or bicarbonate contaminants thereby converting at least some of the contaminants into water and/or carbon dioxide; to reduce the oxygen content of the heating fluid; to remove and/or dissolve and/or destroy asphaltenes, resins, gums and/or sludges; to prevent or inhibit the formation of, or enable the removal of, scale or fouling deposits on metal surfaces; to break-down, suppress, or inhibit the formation of, emulsions or foam (e.g. by adding demulsifier or defoamer); to reduce the cloud point and/or freezing point of liquid contaminants; to neutralise acids and/or increase alkalinity and/or inhibit corrosion; to react with dissolved contaminants and cause precipitation of solid matter that can be removed by mechanical means of separation; and to modify one or more of the properties of the heating fluid including but not limited to density, vapour pressure, viscosity, thermal stability, pH, solubility, heat capacity, corrosivity, thermal conductivity, toxicity, and flammability. The added substances may be added to the heating fluid directly or be added to any of the streams that come into contact with the heating fluid.
Removing at least a portion of the heating fluid and replacing said portion with heating fluid having enhanced properties.
Removing mercury from the heating fluid.
Removing liquid contaminants in liquid form from the flash separator.
Heating at least a portion of the heating fluid to a temperature that causes liquid contaminants to vaporise and flow out of the flash separator.
Operating the flash separator at a temperature and pressure that causes or promotes the break-down of emulsions and/or foams.
Applying an electric charge or current to or across at least a portion of the heating fluid to cause ions of contaminating substances to migrate towards electrodes and thereby be removed.
Removing contaminating particles of solid matter by mechanical means of separation including but not limited to any one or more of: centrifuging, settling, clarifying, filtering, and hydrocycloning, at least a portion of the heating fluid. If necessary, chemicals may be added that cause fine particles of contaminants to flocculate or agglomerate into larger masses that can be removed by mechanical means of separation.
Removing acetate and possibly other organic salt contaminants by mixing acidic solutions, e.g. dilute hydrochloric acid, with at least a portion of the heating fluid to cause a reaction that converts at least a portion of the organic salts into volatile organic acids which can then be vaporised and removed.

### Stage A plus Stage C Configuration

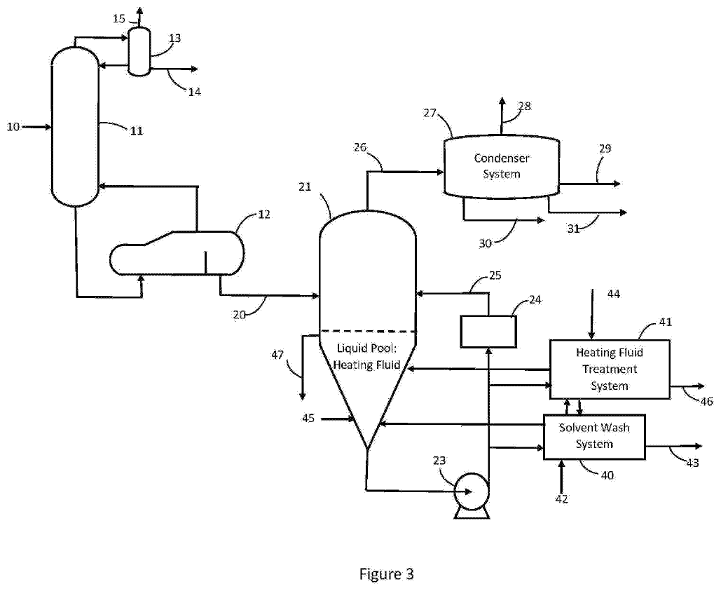

FIG. 3 illustrates a non-limiting example of a system comprising a Stage A (Concentration process) plus Stage C (Flash on Heating Fluid process) configuration. Feed stream 10 comprises water, a water-soluble process liquid that is less volatile than water, dissolved contaminants including monovalent salts (e.g. sodium chloride), divalent ions (e.g. calcium and magnesium), and organic salts (e.g. acetate), and liquid contaminants. Feed stream 10 enters distillation zone 11. Water vapour exits the top of distillation zone 11 and is condensed in condenser 13. Non-condensed gas exits the condenser 13 in stream 15. Bottom liquid from the distillation zone 11 flows to reboiler 12 where it is heated so as to vaporise water and thereby produce concentrated process liquid. Vapour from reboiler 12 flows back into distillation zone 11. Heat is provided to reboiler 12 (e.g. via steam or hot oil in a submerged tube bundle) to vaporise enough water to produce the desired degree of process liquid concentration in the output stream 20 that exits reboiler 12.

Stream 20 comprises the concentrated process liquid that is produced in Stage A and flows into Stage C and is thereby a non-limiting example of what is herein termed the “Stage A output stream”. The Stage A output stream does not necessarily flow immediately from Stage A into Stage C. It can, for example, flow into an intermediate tank, and from there, or from any other suitable location, flow into Stage C. A person skilled in the art will recognise that the Stage A process, which comprises the steps leading up to the creation of the output stream 20 as shown in FIG. 3, is but one non-limiting example out of several potentially feasible alternative designs of systems that can remove water from a feed stream to concentrate a process liquid solution. For example, there are many glycol concentration systems in operation at numerous oil and gas production sites worldwide which comprise a vessel in which there is a submerged tube bundle to perform the reboiler function and a still directly flanged to an upper vapour filled part of the vessel that contains trays or structured packing or random packing to perform the distillation.

Alternative means of separating water from aqueous process liquid solutions to produce a concentrated process liquid may also be feasible (e.g. molecular sieve, membranes).

Stage A Concentration comprises a process that precedes Stage B or Stage C and removes water from the feed stream by any feasible means to produce an output stream of concentrated process liquid.

In one or more embodiments Stage A operates at atmospheric pressure while in other embodiments Stage A operates under vacuum. Operation under vacuum reduces the boiling point of water and can enable Stage A to achieve higher process liquid concentrations at lower temperatures.

With reference to FIG. 3, stream 20 enters flash separator 21 through one or more entrance ports. Flash separator 21 is a Flash on Heating Fluid separation vessel that contains a liquid pool into which separated liquids and solid matter collect. Separated vapour is able to flow out of the upper part of flash separator 21. The liquid pool in flash separator 21 contains heating fluid, which is comprised of liquid components that are less volatile than the process liquid. Pump 23 draws heating fluid out of flash separator 21 and pumps it through heater 24 to create a stream 25 of heated heating fluid. Stream 25 and stream 20 directly contact each other in one or more places upstream of and/or within flash separator 21. For example there may be one or more mixing zones or chambers upstream of flash separator 21 into which both stream 20 and stream 25, or portions thereof, flow and mix with each other, and/or there may be multiple entrance ports into flash separator 21 for stream 20 and stream 25 thereby causing the two streams or portions thereof to mix with each other inside flash separator 21. Alternatively stream 20 or a portion of it may enter the liquid pool in flash separator 21 and therein contact heated heating fluid.

Sufficient heat is added to the heating fluid in heater 24 and/or by heating the heating fluid within flash separator 21 to cause at least a portion of the process liquid in stream 20 to vaporise when stream 20 contacts heated heating fluid.

In embodiments at least all but a negligible remnant, of the process liquid in stream 20 is vaporised as a result of the contact between stream 20 and the heated heating fluid.

In an embodiment over 95%, or preferably over 98%, of the process liquid in stream 20 is vaporised as a result of the contact between stream 20 and the heated heating fluid.

Further descriptions of this configuration of the present disclosure are presented above under the headings Separation and Removal of Contaminants, Heating Fluid Composition, and Heating Fluid Treatment Means.

In the Stage A plus Stage C configuration of the present disclosure the flowrate of the stream entering the Flash on Heating Fluid process (i.e. stream 20) can be substantially less than the flowrate of the feed stream 10. This is possible because the feed stream 10 first enters Stage A which preferably removes most of the water thereby significantly reducing the quantity of liquid that enters the Flash on Heating Fluid process. This can substantially reduce the amount of heat needed to drive the Flash on Heating Fluid process when compared to the prior art (e.g. U.S. Pat. Nos. 8,652,304 and 10,328,360). The heat that is saved in Stage C is approximately equal to the heat that is applied in Stage A. However applying this heat in Stage A enables the use of simpler, lower cost equipment because in Stage A the water can be vaporised at a lower temperature than what is needed to vaporise the less volatile process liquid. Furthermore, the heat of vaporisation of water is substantially greater than that of many process liquids which is another reason to apply such heat using the lower cost Stage A method.

In the non-limiting example of MEG reclamation there are existing gas production sites where it is necessary to treat a salty dilute rich MEG solution (i.e. the feed stream) flowing at 10 m³/h or more. Consider a scenario in which the Stage A plus

Stage C configuration of the present disclosure is used to treat a feed stream 10 having a MEG concentration of 30% and flowing at 10 m³/h into Stage A. Stage A would reconcentrate the MEG solution to 90% concentration by vaporising (in reboiler 12) and removing (in stream 14) about 6.6 m³/h of water. This requires about 4.5 MW of heat to be provided via reboiler 12. This results in a flow of 90% concentrated MEG of about 3.4 m³/h (10 m³/h less 6.6 m³/h) entering Stage C via stream 20, which equates to a 66% smaller flow rate compared to feed stream 10. Stream 20 also comprises salts and other non-vaporised contaminants that had originally been in feed stream 10.

The Stage C Flash on Heating Fluid process in this configuration requires only approximately 1.2 MW of heat to vaporise MEG and water from stream 20, and thereby precipitate and remove monovalent salts (e.g. sodium chloride) and divalent ions (e.g. calcium, magnesium) that had originally been in stream 10. In embodiments Stage C vaporises at least all but a negligible remnant of the MEG in stream 20.

For the example described above the total heat required to fully vaporise the water and MEG in stream 10 would be about 5.7 MW but only 1.2 MW of this heat is needed for Stage C because 4.5 MW is provided in Stage A. By comparison the prior art versions of the Flash on Heating Fluid process (e.g. U.S. Pat. Nos. 8,652,304 or 10,328,360) would require 5.7 MW of heat to remove a similar amount of salt.

The significantly lower heat demand in the Stage C Flash on Heating Fluid process compared to the prior art yields a corresponding reduction in the quantity of heating fluid needed which reduces the cost to purchase and maintain or upgrade the pool of heating fluid and enables the use of smaller and less costly equipment (e.g. pumps, valves, pipes and heaters) to pump and heat the heating fluid.

There is also a reduction in electrical energy demand. The main consumer of electric power in the Stage A plus Stage C configuration illustrated in FIGS. 3 is pump 23 which pumps heating fluid through heater 24 in a pump around loop. The flowrate of this pumped stream varies with the amount of heat needed to drive the vaporisation process, which, as described above, is much lower (i.e. about 80% lower in the above example) in the present disclosure than in the prior art. The prior art does not have a Stage A hence the electrical load in Stage A needs to be accounted for. However, in Stage A the heating method (e.g. submerged tube bundle in reboiler 12) is simpler than in Stage C and typically there is no pump around loop and therefore no large consumer of electric power. The Stage A plus Stage C configuration of the present disclosure thereby provides a means to significantly reduce overall electricity consumption.

### Stage B plus Stage C Configuration

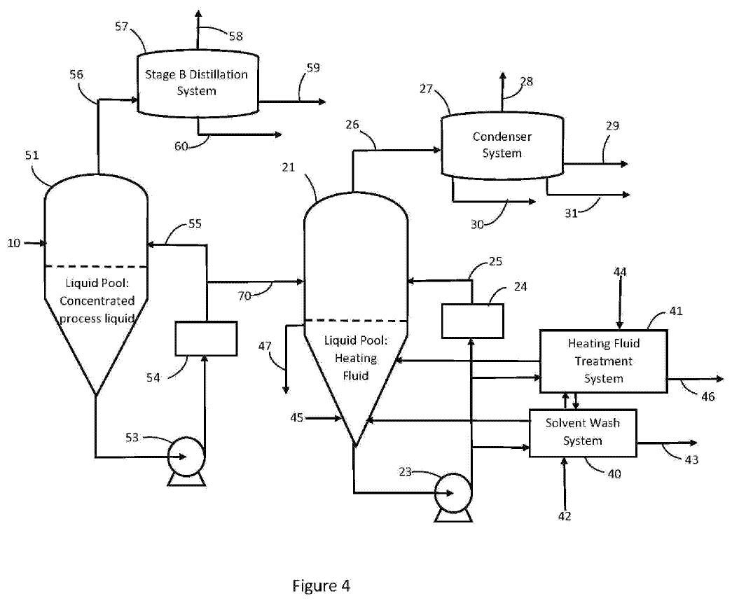

FIG. 4 illustrates a non-limiting example of a Stage B (Flash on Process Liquid process) plus Stage C (Flash on Heating Fluid process) configuration.

Feed stream 10 comprises water, a water soluble process liquid that is less volatile than water, dissolved contaminants including monovalent salts (e.g. sodium chloride), divalent ions (e.g. calcium and magnesium), and organic salts (e.g. acetate), and liquid contaminants.

Stream 10 enters the Stage B separation vessel 51 through one or more entrance ports. The liquid pool in the lower part of Stage B separation vessel 51 contains a liquid which is comprised of concentrated process liquid. Stage B pump 53 draws concentrated process liquid out of the liquid pool in Stage B separation vessel 51 and pumps it through Stage B heater 54 to create a stream 55 of heated concentrated process liquid. Stream 55 and stream 10 directly contact each other in one or more places upstream of and/or within Stage B separation vessel 51. For example there may be one or more mixing zones or chambers upstream of Stage B separation vessel 51 into which both stream 10 and stream 55, or portions thereof, flow and mix with each other, and/or there may be multiple entrance ports into Stage B separation vessel 51 for both stream 10 and stream 55 thereby causing the two streams or portions thereof to mix with each other inside Stage B separation vessel 51 and/or stream 10 or a portion thereof, may enter the liquid pool in Stage B separation vessel 55 and therein contact heated concentrated process liquid.

Sufficient heat is added to the stream of concentrated process liquid in Stage B heater 54 to cause at least a portion of the water and process liquid in stream 10 to vaporise when stream 10 and stream 55 contact each other.

Vapour, which comprises vaporised process liquid and water and optionally liquid contaminants, exit the Stage B separation vessel 51 and flow via stream 56 into the Stage B distillation system 57. A person skilled in the art will recognise that separation and condensation of components of the vapour can be achieved using standard methods (e.g. vacuum distillation). The Stage B distillation system 57 includes equipment to enable operation of Stage B separation vessel 51 at sub-atmospheric pressure. Stream 58 comprises non-condensed gases and vapour that are subsequently removed. Stream 59 is an output product stream that may comprise process liquid that is depleted of salts and other contaminants. Stream 60 is optional and may comprise condensed liquid contaminants (if present) that are subsequently removed.

A second output stream 70 may convey contaminated process liquid into Stage C thereby moving salts and possibly other contaminants out of Stage B and into Stage C wherein they will be separated and removed. The term “Stage B to C stream” as used herein means the stream (for example stream 70) that conveys a mixture comprising at least a portion of the contaminants and at least a portion of the unvaporised process liquid from Stage B into Stage C.

Stage B differs markedly from the prior art versions of the Flash on Process Liquid process. In said prior art (U.S. Pat. Nos. 6,685,802 and 8,728,321) the process proceeds beyond the point that salts and other dissolved substances precipitate and begin to accumulate in the large pool of concentrated process liquid in the separation vessel. The rate of salt accumulation can be massive in MEG reclamation systems (e.g. over 5 tonnes per day). In the absence of further steps the accumulation of precipitated salts can rapidly become intolerable and cause a shutdown of the reclamation system. For this reason the prior art relies on mechanical means to separate the large quantities of precipitated solid matter from the concentrated process liquid (e.g. settling tank, clarifier, filter, centrifuge, salt downcomer).

In contrast, in this Stage B plus Stage C configuration of the present disclosure the precipitation of salts is controlled such that there is no excessive accumulation of precipitated solid matter in Stage B. Hence the present disclosure enables the deletion of the mechanical separation systems from the Flash on Process Liquid process, thereby significantly reducing complexity and cost. The avoided equipment which can include centrifuge, settling tanks, filters, salt tank, downcomer etc is typically large, complex, heavy, expensive to purchase, operate and maintain. The deletion of this equipment results in a simpler safer system that can be built and operated at lower cost. Salts must be removed but this is primarily done using simpler, lower cost, non-mechanical means in the Stage C Flash on Heating Fluid process that reduce the risk of loss of process liquid and harm to the environment.

In the non-limiting example of MEG reclamation sodium chloride, potassium chloride and optionally other monovalent salts precipitate and form a slurry with concentrated MEG in the liquid pool of the Stage B separation vessel 51. However divalent ions remain dissolved in the concentrated MEG thereby avoiding the risk of divalent ions combining with MEG to form unwanted complex compounds (e.g.

calcium-MEG-chloride, magnesium-MEG-chloride) which are known to person skilled in the art as particularly problematic in MEG reclamation systems. This divalent ion problem is discussed in Reference 1. The present disclosure avoids said divalent ion risks by ensuring that there is a sufficient flow of the mixture of salts and process liquid from Stage B via stream 70 into Stage C. FIG. 4 illustrates one embodiment wherein stream 70 is a portion of the heated output from Stage B heater 54. A person skilled in the art will recognise that stream 70 could alternatively be drawn from a location upstream of the Stage B heater 54 or from a tank where salts and concentrated process liquid from the Stage B separation vessel have been collected or from another equivalent location.

The present disclosure includes means to directly control the flow rate in stream 70 thereby preventing unwanted accumulation of divalent ions in Stage B. This feature adds considerable value to the present disclosure which can be illustrated by considering the non-limiting example of MEG reclamation. Consider the same scenario described earlier namely a 10 m³/h feed stream 10 comprising 30% MEG. This feed stream also contains 20 g/ltr of monovalent salts and 1 g/ltr of divalent ion salts. These salt concentrations are typical of many gas production sites worldwide where saline formation water is produced with the natural gas.

Steady flow at the above conditions results in a daily monovalent salt load of about 4,800 kg/d and a divalent ion salt load of about 250 kg/d. For these conditions the stream 70 flow can be regulated to maintain a flow rate of about 1 m³/h. This flow may appear small but it is high enough to ensure that the precipitated monovalent salt concentration in the Stage B separation vessel 51 remains below about 7 vol %. This is readily tolerable given that many existing MEG reclamation systems routinely work with MEG salt slurries having higher salt concentration. This flow is also sufficient to ensure that the divalent ions (especially calcium) remain dissolved at a concentration of less than about 4 g/ltr. This concentration of divalent ions in the pool of concentrated MEG in Stage B separation vessel 51 is readily tolerable and well below the suggested limit of 10 g/ltr proposed by experienced MEG reclamation system designers and operators (reference 1).

Stream 70 enters the flash separator 21 through one or more entrance ports. The liquid pool in the lower part of the flash separator 21 contains heating fluid, which is comprised of liquid components that are less volatile than the process liquid. Pump 23 draws heating fluid out of the flash separator 21 and pumps it through heater 24 to create a stream 25 of heated heating fluid. Stream 25 and stream 70 directly contact each other in one or more places upstream of and/or within flash separator 21. For example there may be one or more mixing zones or chambers upstream of flash separator 21 into which both stream 70 and stream 25, or portions thereof, flow and mix with each other, and/or there may be multiple entrance ports into flash separator 21 for both stream 70 and stream 25 thereby causing the two streams or portions thereof to mix with each other inside flash separator 21. Alternatively stream 70 or a portion of it may enter the liquid pool in flash separator 21 and therein contact heated heating fluid.

Sufficient heat is added to the heating fluid in heater 24 and/or by heating the heating fluid within flash separator 21 to cause at least a portion of the process liquid in stream 70 to vaporise when stream 70 contacts heated heating fluid.

In embodiments at least all but a negligible remnant, of the process liquid in stream 70 is vaporised as a result of the contact between stream 70 and the heated heating fluid.

In an embodiment over 95%, or preferably over 98%, of the process liquid in stream 70 is vaporised as a result of the contact between stream 70 and the heated heating fluid.

Further descriptions of this configuration of the present disclosure are presented above under the headings Separation and Removal of Contaminants, Heating Fluid Composition, and Heating Fluid Treatment Means.

When compared to the Stage C system in the Stage A plus Stage C configuration the Stage C system in the Stage B plus Stage C configuration is more compact and consumes even less energy. Consider the same MEG reclamation scenario as described previously i.e. the Stage B plus Stage C configuration is used to treat a 10 m³/h feed stream having a MEG concentration of 30%. Stage B comprises a Flash on Process Liquid process to produce an output product stream 59 comprising salt depleted (or salt free) concentrated MEG. This requires about 5.4 MW of heat that may be provided via the Stage B heater 54.

Stream 70 carries salts, possibly other contaminants and concentrated MEG from Stage B to Stage C at a flow rate of about 1.0 m³/h, which is 90% lower than the feed stream 10 flow rate of 10 m³/h. As a result of being able to operate Stage C at such a low flow rate, the amount of heat needed in Stage C is only about 0.3 MW. Stage C precipitates and removes monovalent salts (e.g. sodium chloride) and divalent ions (e.g. calcium and magnesium) that had originally been in stream 10. In embodiments Stage C vaporises at least all but a negligible remnant of the MEG in stream 70.

For the example described above the total heat required to fully vaporise the water and MEG in stream 10 is about 5.7 MW, which is approximately what would need to be provided when applying only the Flash on Heating Fluid process described in the prior art (e.g. U.S. Pat. Nos. 8,6752,304 or 10,328,360). By comparison the Flash on Heating Fluid process in this Stage B plus Stage C configuration only requires 0.3 MW of heat.

The significantly lower heat demand in the Stage C Flash on Heating Fluid process compared to the prior art yields a corresponding reduction in the quantity of heating fluid needed which reduces the cost to purchase and maintain or upgrade the pool of heating fluid.

It is possible to use the method of the present disclosure in a batch or continuous manner.

Persons of ordinary skill can utilise the disclosures and teachings herein to produce other embodiments and variations without undue experimentation. All such embodiments and variations are considered to be part of the present disclosure. Accordingly, one of ordinary skill in the art will readily appreciate from the disclosure that later modifications, substitutions, and/or variations performing substantially the same function or achieving substantially the same result as embodiments described herein may be utilised according to such related embodiments of the present disclosure. Thus, the disclosure is intended to encompass, within its scope, the modifications, substitutions, and variations to processes, manufactures, compositions of matter, compounds, means, methods, and/or steps disclosed herein. The description herein may contain subject matter that falls outside of the scope of the claimed disclosure. This subject matter is included to aid understanding of the disclosure.

In this specification, where reference has been made to external sources of information, including patent specifications and other documents, this is generally for the purpose of providing a context for discussing the features of the present disclosure. Unless stated otherwise, reference to such sources of information is not to be construed, in any jurisdiction, as an admission that such sources of information are prior art or form part of the common general knowledge in the art.

### Reference

1. “Removal of Divalent Salts from Aqueous MEG Solutions in a MEG Reclamation System”, GPA Europe Annual Conference, September 2011, Simon Crawley-Boevey

1. A method of removing contaminants, including dissolved contaminants, from a feed stream, said feed stream comprising water and said contaminants and a process liquid that is water soluble and less volatile than water, said method comprising the following steps:
heating a heating fluid comprised of components that are immiscible with a salt solvent and less volatile than the process liquid to produce a heated heating fluid;
bringing at least a portion of the feed stream into contact with at least a portion of the heated heating fluid at one or more places that are upstream of and/or within a flash separator to vaporise at least a portion of the process liquid thereby causing at least a portion of the dissolved contaminants to form precipitated solid matter;
enabling at least a portion of the heating fluid to mix with at least a portion of the precipitated solid matter thereby producing a depleted mixture that comprises at least a portion of the heating fluid and at least a portion of the precipitated solid matter; and
bringing the salt solvent into contact with at least a portion of the depleted mixture whereby said salt solvent dissolves at least a portion of the precipitated solid matter, to create a waste solution that comprises at least a portion of the dissolved contaminants.

2. A method of removing contaminants, including dissolved contaminants, from a feed stream, said feed stream comprising water and said contaminants and a process liquid that is water soluble and less volatile than water, said method comprising the following steps:
applying a concentration process to remove water from at least a portion of the feed stream to produce a Stage A output stream having a concentration of process liquid that is higher than that of the feed stream;
heating a heating fluid comprised of components that are immiscible with a salt solvent and less volatile than the process liquid to produce a heated heating fluid;
bringing at least a portion of the Stage A output stream into contact with at least a portion of the heated heating fluid at one or more places that are upstream of and/or within a flash separator to vaporise at least a portion of the process liquid thereby causing at least a portion of the dissolved contaminants to form precipitated solid matter;
enabling at least a portion of the heating fluid to mix with at least a portion of the precipitated solid matter thereby producing a depleted mixture that comprises at least a portion of the heating fluid and at least a portion of the precipitated solid matter; and
bringing the salt solvent into contact with at least a portion of the depleted mixture, whereby said salt solvent dissolves at least a portion of the precipitated solid matter to create a waste solution that comprises at least a portion of the dissolved contaminants.

3. A method of removing contaminants, including dissolved contaminants, from a feed stream, said feed stream comprising water and said contaminants and a process liquid that is water soluble and less volatile than water, said method comprising the following steps:
heating a concentrated process liquid to produce heated concentrated process liquid;
bringing at least a portion of the feed stream into contact with at least a portion of the heated concentrated process liquid at one or more places that are upstream of and/or within a Stage B separation vessel to vaporise a portion of the process liquid thereby producing an unvaporised liquid that comprises at least a portion of the dissolved contaminants;
enabling at least a portion of the unvaporised liquid to mix with at least a portion of the concentrated process liquid thereby producing a Stage B to C stream that comprises at least a portion of the process liquid and at least a portion of the dissolved contaminants;
heating a heating fluid comprised of components that are immiscible with a salt solvent and less volatile than the process liquid to produce a heated heating fluid;
bringing at least a portion of the Stage B to C stream into contact with at least a portion of the heated heating fluid at one or more places that are upstream of and/or within a flash separator to vaporise at least a portion of the process liquid thereby causing at least a portion of the dissolved contaminants to form precipitated solid matter;
enabling at least a portion of the heating fluid to mix with at least a portion of the precipitated solid matter thereby producing a depleted mixture that comprises at least a portion of the heating fluid and at least a portion of the precipitated solid matter; and
bringing the salt solvent into contact with at least a portion of the depleted mixture whereby said salt solvent dissolves at least a portion of the precipitated solid matter, thereby creating a waste solution that comprises at least a portion of the dissolved contaminants.

4. The method as claimed in claim 2 wherein the concentration process comprises heating the feed stream to a temperature sufficient to vaporise and remove at least a portion of the water.

5. The method as claimed in claim 3 further including the step of regulating the flow of the Stage B to C stream to limit the accumulation of at least a portion of the dissolved contaminants in the Stage B separation vessel.

6. The method as claimed in claim 1 further including the step of applying one or more heating fluid treatment means to decontaminate at least a portion of the heating fluid.

7. The method as claimed in claim 1 further including the step of applying one or more heating fluid treatment means to at least a portion of the heating fluid to modify one or more properties of the heating fluid, including but not limited to density, vapour pressure, viscosity, thermal stability, pH, solubility, heat capacity, thermal conductivity, corrosivity, toxicity, and flammability.

8. The method as claimed in claim 6 wherein the one or more heating fluid treatment means include adding one or more substances and mixing said added substances with at least a portion of the heating fluid to achieve any one or more of the following effects: to cause a reaction with carbonate and/or bicarbonate contaminants thereby producing water and/or carbon dioxide; to reduce the oxygen content of the heating fluid; to remove and/or dissolve and/or destroy asphaltenes, resins, gums and/or sludges; to prevent or inhibit the formation of, or enable the removal of, scale or fouling deposits on metal surfaces; to break-down, suppress, or inhibit the formation of, emulsions or foam; to reduce the cloud point and/or freezing point of liquid contaminants; to neutralise acids and/or increase alkalinity and/or inhibit corrosion; and to react with dissolved contaminants and cause precipitation of solid matter that can be removed by mechanical means of separation.

9. The method as claimed in claim 6 wherein the one or more heating fluid treatment means include heating at least a portion of the heating fluid to vaporise and thereby remove at least a portion of the liquid contaminants.

10. The method as claimed in claim 6 wherein the one or more heating fluid treatment means include removing contaminating particles of solid matter from at least a portion of the heating fluid by mechanical means of separation including but not limited to any one or more of: centrifuging, settling, clarifying, filtering, and hydrocycloning.

11. The method as claimed in claim 6 wherein the one or more heating fluid treatment means include adding one or more substances and mixing said added substances with at least a portion of the heating fluid to cause a reaction that converts at least a portion of the organic salt contaminants into volatile organic acids and vaporising at least a portion of said volatile organic acids.

12. The method as claimed in claim 7 wherein the one or more heating fluid treatment means include adding one or more substances and mixing said added substances with at least a portion of the heating fluid to modify one or more properties of the heating fluid, including but not limited to density, vapour pressure, viscosity, thermal stability, pH, solubility, heat capacity, thermal conductivity, corrosivity, toxicity, and flammability.

13. The method as claimed in claim 1 wherein the heating fluid comprises components that are immiscible with the process liquid.

14. (canceled)

15. The method as claimed in claim 1 wherein the process liquid comprises any one or more liquids selected from the group comprising: mono-ethylene glycol; diethylene glycol; triethylene glycol; and
amines.

16. The method as claimed in claim 1 wherein the dissolved contaminants comprise any one or more of: monovalent salts including sodium chloride; divalent ions including calcium; and organic acid salts including acetate.

17. The method as claimed in claim 1 wherein at least all but a negligible remnant of the process liquid that contacts the heated heating fluid is vaporised.

18-19. (canceled)

20. The method as claimed in claim 1 wherein the heating fluid comprises one or more liquid components selected from any of the following groups: oils; fatty acids; heat transfer fluids; liquid metals;
ionic liquids; and deep eutectic solvents.

21. The method as claimed in claim 1 wherein at least a portion of the salt solvent enters the flash separator and mixes with depleted mixture and dissolves at least a portion of the precipitated solid matter thereby creating a waste solution that comprises at least a portion of the dissolved contaminants.

22. The method as claimed in claim 1 wherein at least a portion of the depleted mixture moves into a solvent wash system wherein at least a portion of the precipitated solid matter dissolves in at least a portion of the salt solvent, thereby creating a waste solution that comprises at least a portion of the dissolved contaminants.

23. (canceled)
